(19) United States
(12) Patent Application Publication
(10) Pub. No.: US 2026/0092860 A1
(43) Pub. Date: Apr. 2, 2026

(54) OPTICAL INTERROGATION DEVICE AND ASSOCIATED PROCESS

(71) Applicant: THE ROYAL INSTITUTION FOR THE ADVANCEMENT OF LEARNING/MCGILL UNIVERSITY, Montréal (CA)

(72) Inventors: Sara MAHSHID, Mont-Royal (CA); Mahsa JALALI, Boucherville (CA)

(21) Appl. No.: 19/124,000

(22) PCT Filed: Oct. 23, 2023
(86) PCT No.: PCT/CA2023/051406

§ 371 Date: Apr. 24, 2025

Related U.S. Application Data
(60) Provisional application No. 63/418,653, filed on Oct. 24, 2022.

(51) Int. Cl. G01N 15/1434; G01N 15/00; G01N 15/01

(52) U.S. Cl. CPC G01N 15/1434; G01N 15/01; G01N 2015/0038

(57) ABSTRACT

The optical interrogation device can have a substrate; an insulating layer supported by the substrate; a plasmonic layer supported by the substrate via the insulating layer; a cavity extending across both the plasmonic layer and the insulating layer to a bottom adjacent the substrate, the cavity being sized to receive a particle; and a layer of 2D material covering the substrate and defining the bottom of the cavity. The process of optically interrogating the particle can include the layer of 2D material attracting the particle into the cavity across the upper end, and, while the particle is in the cavity, acquiring an optical signal including a spectral signature of the particle.

### BACKGROUND

Technological developments which have occurred over the last decades have led to an increased availability of technologies for acquiring information about small particles, which can be particularly useful in analyzing biological particles. However, there remains much room for improvement. Indeed, while electromagnetic (e.g., optical) signal interrogation techniques such as surface enhanced Raman spectroscopy (SERS) have a high potential of acquiring information about small particles, there remains many challenges to make these technologies practical for commercial use. In particular, the handling of particles can be challenging, especially if it is desired to isolate individual particles in a manner to allow their individual characterization.

For instance, monitoring cell transforming events throughout different disease processes (e.g., cancer) can be an important key for treatment decisions. Mutational and epigenetic driver events profoundly alter the release, molecular composition, and biological activity of extracellular vesicles, particularly those of the exosome-type which can have a nanometer-range size ranging 30-200 nm, and membranous cellular fragments filled with bioactive molecular cargo. Molecular profiling of single extracellular vesicles to study their architecture and composition can reveal comprehensive realization of cell (cancer) transforming events and shed new light on their diagnostic expediency.

Even taking for granted that technologies allowing to acquire relevant information about individual extracellular vesicles can be developed, several challenges would remain in devising practical solutions adapted for widespread use. In particular, relatively frequent monitoring may not be considered feasible if it requires sending samples to remote locations for lengthy and/or costly analysis. A need for improvement was thus strongly felt.

### SUMMARY

In a general aspect of the present disclosure, there is described a floating plasmonic cavity embedded with an attracting layer of 2D material at the bottom of the cavity. The cavity can be sized as a function of an expected particle size which is intended to be captured, such as in a manner to be just the right size to accommodate a particle and retain it long enough for observation. An insulator layer can be used to adapt the depth of the cavity to this end, and the insulator layer can also simultaneously provide a spacing between a plasmonic material layer and the attracting layer, which may protect the biological particle from damage which could otherwise result from the electromagnetic interrogation in some embodiments such as those implying SERS. The material of the insulator layer can be adapted for biocompatibility of the interior wall of the cavity. The thickness of the plasmonic material layer can be adapted as a function of the optical interrogation technique which is being used in the specific embodiment. In some embodiments, the choice of 2D material parameters can enhance light-matter interaction of the interrogation technique when coupled with the plasmonic material layer, which can be the case of some transition metal dichalcogenide materials such as molybdenum disulfide (MoS₂) in particular which was further found suitable for use in attracting extracellular vesicles, stable at room temperature, and well adapted to surface enhanced fluorescent microscopy of extracellular vesicles using conventional bright field fluorescent microscopes. Moreover, given the intrinsically attractive properties of 2D materials, they can be used for analysing not only known particles, but also unknown particles. Such a platform can be implemented on different substrates, such as silica, flexible polymers, ITO coated glass, etc., which can provide flexibility for adaptation to different contexts and applications. A plurality of such cavities can be embodied as an array for convenient sequential or parallel interrogation.

In accordance with a first aspect of the present disclosure, there is provided an optical interrogation device comprising: a substrate; an insulating layer supported by the substrate; a plasmonic layer supported by the substrate via the insulating layer; a cavity extending across both the plasmonic layer and the insulating layer to a bottom adjacent the substrate, the cavity being sized to receive a particle; and a layer of 2D material covering the substrate and defining the bottom of the cavity. The 2D material can be intrinsically attractive to the particle.

In accordance with a second aspect of the present disclosure, there is provided a process of optically interrogating a particle in a fluid sample, the process comprising: positioning the fluid sample containing the particle in the vicinity of a cavity having an open upper end and a lower end closed by a layer of 2D material; the layer of 2D material attracting the particle into the cavity across the upper end; and while the particle is in the cavity, acquiring an optical signal including a spectral signature of the particle.

In accordance with a third aspect of the present disclosure, there is provided a microfluidic device comprising: a base plate defining a microfluidic conduit extending between an inlet and an outlet; an optical interrogation device disposed within the microfluidic conduit, the optical interrogation device having: a substrate, an insulating layer supported by the substrate, a plasmonic layer supported by the substrate via the insulating layer, a cavity extending across both the plasmonic layer and the insulating layer to a bottom adjacent the substrate, the cavity being sized to receive a particle, and an attracting layer of 2D material covering the substrate and defining the bottom of the cavity, the 2D material being intrinsically attractive to the particle, wherein, as a fluidic stream carrying the particle flows from the input towards the outlet, the particle is attracted within the cavity for optical interrogation.

In accordance with a fourth aspect, there is provided an optical interrogation device comprising: a substrate; an insulating layer supported by the substrate; a plasmonic layer supported by the insulating layer; a cavity extending across both the plasmonic layer and the insulating layer to a bottom adjacent the substrate, the cavity being sized to receive a particle; and a layer of 2D material covering the substrate and defining the bottom of the cavity.

In accordance with a fifth aspect, there is provided a process of optically interrogating a particle in a fluid sample, the process comprising: exposing the fluid sample to a cavity having an open upper end and a lower end closed by a layer of 2D material; the layer of 2D material attracting the particle into the cavity across the upper end; and while the particle is in the cavity, acquiring an optical signal including a spectral signature of the particle.

In accordance with a sixth aspect, there is provided a structure for enhancing and isolating optical signals from individual nanosized particles having between 25 and 1000 nm in diameter, the structure comprising: a substrate layer; an electromagnetically insulating layer supported by the substrate, the electromagnetically insulating layer having a thickness between 20 and 600 nm; a plasmonically active layer supported by the electromagnetically insulating layer, the plasmonically active layer having a thickness between 5 and 400 nm; a cavity extending across both the plasmonically active layer and the insulating layer to a bottom, the cavity having a cross-sectional width less than or equal to a sum of the thickness of the electromagnetically insulating layer and the thickness of the plasmonically active layer; and a 2D transition metal dichalcogenide layer at the bottom of the cavity.

Many further features and combinations thereof concerning the present improvements will appear to those skilled in the art following a reading of the instant disclosure.

### DESCRIPTION OF THE FIGURES

In the figures,

FIG. 1 is a schematic, oblique cross-sectional view of an example of an optical interrogation device;

FIG. 2 is a schematic process flow representing an example method of fabricating the optical interrogation device of FIG. 1;

FIG. 3A is a schematic representation of an example optical interrogation system and method of use, in particular, FIG. 3A represents the concept of using a MoSERS on-chip liquid biopsy performed based on SERS identification of single EVs via monolayer MoS₂ embedded plasmonic nanocavities. Training different machine learning systems with a variety of transformed and non-transformed cell lines, in a manner for the Al-connected MoSERS to be able to distinguish between healthy individuals and Glioblastoma patients.

FIG. 3B represents single EV entrapment in the plasmonic nanocavities for single EV resolution SERS (left). The physical studies of the MoSERS plasmonic nanocavities display the potency of the EF enhancement to amplify the SERS signals (right).

FIG. 4. (a) the SERS spectra of R6G in a range of concentrations from 0.01-200 μM. (b) The sensitivity test of R6G on MoSERS substrate showing a linear range from 0.1-200 UM with R2 value of 0.996. (c) The SERS intensity of the representative peaks at 612 cm-1, 1181 cm⁻¹, and 1510 cm⁻¹ on MoSERS nanocavities (Red) and flat silver thin film (Black).

FIG. 5. (a) The correlated SEM images of the fabricated nanocavities with 100-200 nm in diameters. (b) SEM images of single EVs entrapped in the MoSERS nanochip. (c) SEM micrograph SEM image of EVs on the monolayer MoS₂ showing their tendency towards binding with the edges. (d) The TEM image showing the co-existence of MoS₂ and a single EV. (e) High-resolution TEM image of monolayer MoS₂ and corresponding SAED pattern in the inset confirming the 2H-phase of the monolayer MoS₂. (f) large area EDS mapping with correlated HAADF image in the inset of the MoSERS nanochip.

FIG. 6 Single EV SERS spectra of EV populations derived from 10 different cell species.

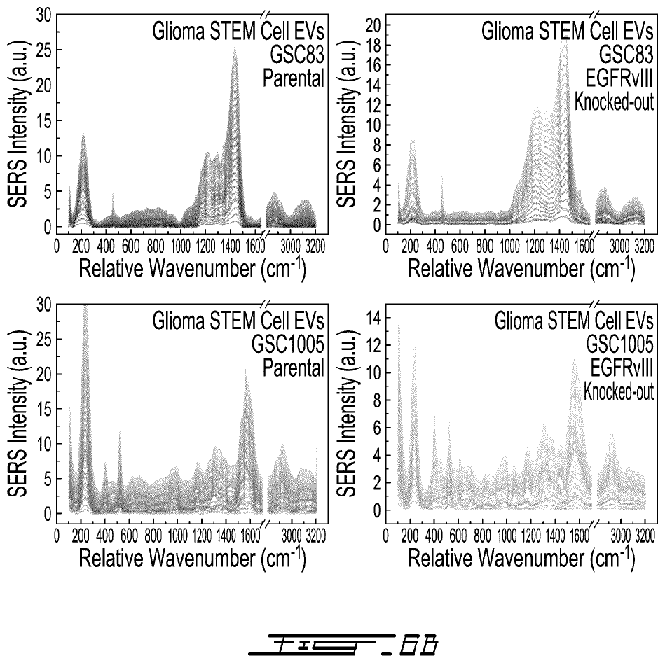

FIG. 7 PCA score plot of the SERS data comparing (a) NHA non-cancerous cells with glioma EVs (U87 and U373), (b) Parental, EGFRvIII and PTEN expressed glioma EVs (U87 and U373), (c) NHA non-cancerous cells with glioma stem cell EVs (GSC83 and GSC1005), (d) Parental and EGFRvIII knocked-out expressed glioma stem cell EVs (GSC87 and GSC1005).

FIG. 8A. EVs entrapment in MoSERS nanocavities. The averaged SERS spectra from empty cavities (buffer), liposomes, EV populations derived from non-cancerous glial cells (NHA) and cultured glioma cells (U373). Each spectrum is obtained from averaging 50 EVs; the SD is indicated in gray.

FIG. 8B. PCA components (i.e., PCA score plot) for single EV recordings obtained with the MoSERS platform.

FIG. 9. MoSERS profiles of blood-borne EVs from GBM patients harbouring distinct molecular alterations, showing samples with positive variants of EGFR amplification, EGFRvIII and MGMT methylation were pooled and classified by the probability distribution of each sample.

FIG. 10 shows an oblique view of an example of a microfluidic device, in accordance with one or more examples.

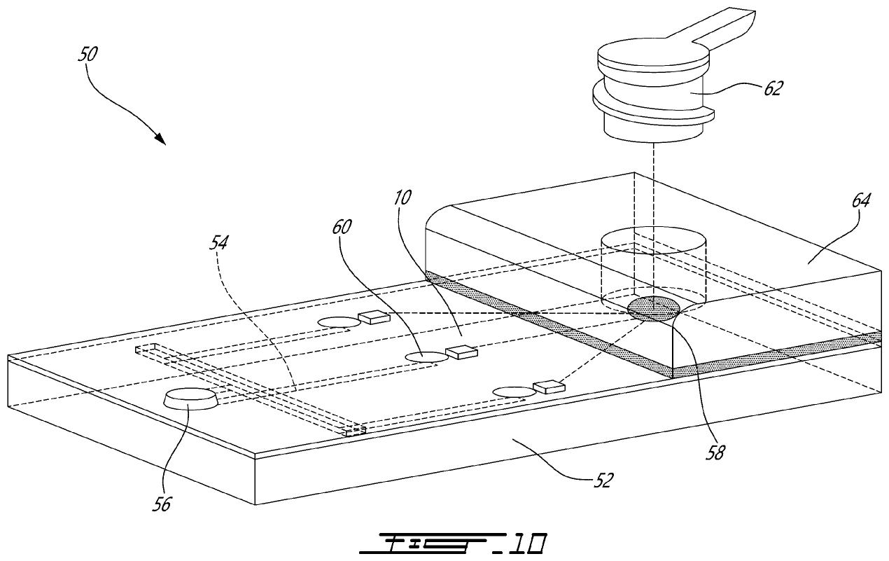

### DETAILED DESCRIPTION

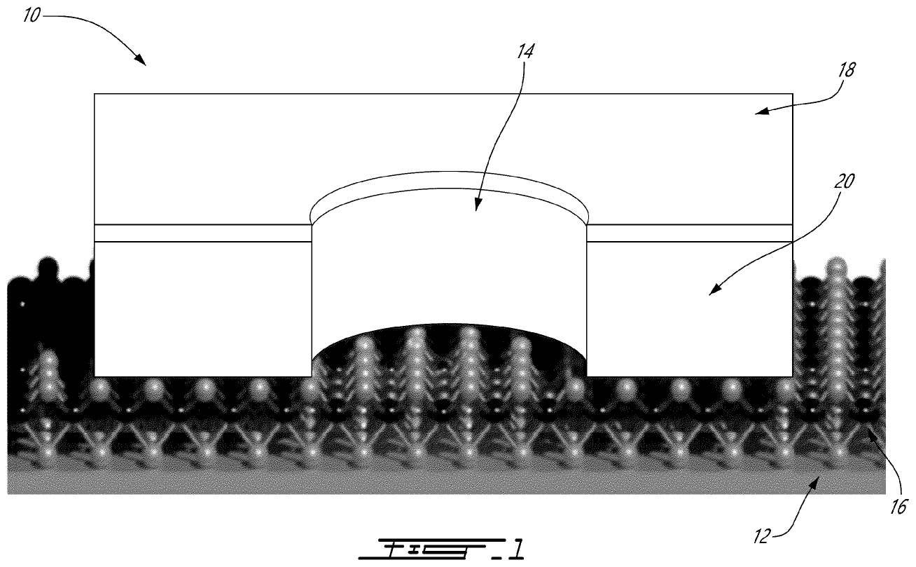

FIG. 1 shows an example embodiment of an optical interrogation device 10. The optical interrogation device 10 is generally embodied on a substrate 12 which acts as a support layer or base. The substrate 12 can be a silica-based board for instance, or any other suitable rigid or semi-rigid substrate. The optical interrogation device 10 also has at least one cavity 14, which can alternately be referred to as a pore. The cavity 14 has a nanometer-range size which is adapted to the expected size of the known or unknown particle(s), and can be selected based on testing in a manner to be sufficiently large to accommodate the particle(s) while allowing a sufficiently tight fit to allow retaining the targeted biological particle received in the cavity long enough to perform the electromagnetic/optical interrogation. The attraction of the targeted biological particle into the cavity 14 can be performed by an attracting layer 16 which forms the bottom of the cavity. The attracting layer 16 can be a suitable 2D material. The 2D material can have one to a few layers of crystalline material. The number of layers at which a material begins to lose its 2D properties such as intrinsic attractiveness or band gap can vary as a function of the material, and a material which can exhibit 2D properties will typically be expected to lose its 2D properties and act as a bulk material within a range of a few layers or a certain thickness. 2D materials can have intrinsically attractive properties and may not require functionalizing/labeling with an additional material (e.g., antibody) or biomarker, and can be stable at room temperature, which can be very convenient for practical considerations and open the way to sampling a broader range of particles having unknown identities or properties in addition to particles having known identities and properties. As will be seen in greater detail below, the choice of the attractive material can be made as a function of the intended end-use, and in addition to taking into consideration the properties of the particle, it can further take into consideration the context and requirements of the electromagnetic interrogation technique. The attracting layer 16 can be optically and chemically active 2D material which can be used to entrap unitary particles of interest such as single-extracellular vesicle in the cavity without using antibodies.

In this example embodiment, the cavity 14 is formed across a surface layer 18 of plasmonic material and a subjacent layer of insulating material 20. The plasmonic material can be a suitable plasmonic metal, such as silver, gold or aluminum for instance. The cavity size, the type of plasmonic material and the thickness of the plasmonic material are parameters which can be selected as a function of the intended end-use. In many embodiments, it can be convenient to use a nanometer cavity size between 30 nm and 600 nm in depth and width. For spherical particles for instance, using a depth which is equal to the width (or transversal diameter in the case of a cylindrical cavity) can be suitable. In an embodiment having a plurality of cavities, size distribution of the cavities can be used to sort particle types. In some embodiments, maximum electromagnetic field distribution, and thus optical interrogation sensitivity, can be achieved in a cavity size range of between 100 and 250 nm. Indeed, in such embodiments, the electromagnetic field distribution can fade slowly between 250 nm and 600 nm, and more abruptly above 600 nm. Fabrication considerations can be dissuasive for making cavity sizes below 30 nm as the costs can increase exponentially as a function of reduction in size within that range, but on the other hand, most biological particles (e.g., bioanalytes) can have a size over 30 nm making cavity sizes above 30 nm quite suitable for many biological applications.

The parameters of the plasmonic material can be instrumental in achieving a suitable sensitivity in an interrogation technique such as SERS for instance. If the plasmonic material is too thick, for instance, it may dissipate plasmonic resonances and lead to unsatisfactory sensitivity for instance. In many embodiments, a plasmonic layer (i.e. a plasmonically active layer) having a thickness of between 5 nm and 200 nm can be considered suitable. Above 200 nm in thickness, an increase of electron loss within the layer may be expected to occur, which can significantly affect electromagnetic field strength, and thus sensitivity of the optical interrogation. The selection of parameters for the plasmonic layers can be strongly dependent on a type of laser used for optical interrogation since it can define the absorption wavelength. Smaller thickness can be preferable for smaller particles while greater thickness (within a suitable range) may be acceptable or even preferred for larger particles. The final selection of the plasmonic material parameters may be made based on testing with the specific end-use in mind. It will be noted here that the cavity forms part of the electromagnetic context as electromagnetic waves/field can extend into and be shaped in part by the cavity. As such, the cavity can be referred to as a plasmonic cavity.

The functionality of the insulating material can be twofold. Firstly, it may be used to adapt the size of the cavity 14 as a function of the targeted biological particle(s) without increasing the thickness of the plasmonic material layer 18. Secondly, it was found that the attracting layer 16 also forms part of the electromagnetic context together with the plasmonic layer 18 and the interrogation system, and can affect the readout and the sensitivity. In particular, if the attracting layer 16 is too close to the plasmonic material layer 18, the attracting layer 16 may interfere with the plasmonic resonances which may negatively affect sensitivity. Accordingly, the insulating layer 20 (i.e. electromagnetically insulating layer) can further act as a neutral spacer to keep the plasmonic layer 18 sufficiently spaced apart from the attracting layer 16 and allow a suitable material for acting as a peripheral wall of the cavity. The plasmonic layer thickness can be between 5 nm and 400 nm for instance, such as between 5 nm and 100 nm. The insulating layer 20 thickness can be between 20 and 600 nm for instance. The cavity diameter can be less than or equal to the sum of the thickness of the plasmonic layer 18 and the insulator layer 20. In many embodiments where the plasmonic layer thickness is between 5 nm and 100 nm, selecting an insulating layer thickness of between 1 and 4 times the plasmonic layer thickness can be suitable. For many embodiments where the plasmonic layer thickness is between 100 and 200 nm, selecting an insulating layer thickness having the same thickness as the plasmonic layer thickness can be suitable. One driving factor in the choice of insulating layer thickness can be the expected analyte (particle) size, and for embodiments expecting spherical analytes, cylindrical cavities can be used where the cavity diameter matches cavity depth, and where the cavity depth is defined by the combined thicknesses of the insulator layer 20 and of the plasmonic layer 18. Various materials can be considered suitable insulating layer materials and the exact choice may highly depend on the intended end use. Zinc oxide (ZnO) can be suitable in the example embodiment. Other nitride-based or oxide-based insulator materials are believed to be equally suitable, to name some potential examples. For instance, titanium oxide has been tested and shown to work. Generally, it is believed that other electromagnetic insulator layers should work. Other potential materials: many other possibilities exist, such as electrically insulating polymers (e.g. parylene), polyimide, positive photo resist materials, epoxy-based negative photoresist such as SU8, Hydrogen Silsesquioxane (HSQ), microchemicals manufactured under the AZ-MIR™ brand. In the embodiment presented in FIG. 1, a plasmonic floating metasurface can be said to be achieved.

In this example embodiment, the optical interrogation device 10 is specifically adapted to for acquiring an optical signal containing a signature associated to one or more type of extracellular vesicles, via an interrogation technique such as SERS. A few parameters can thus be adapted specifically to this end use. In particular, extracellular vesicles can have a size between 30 and 200 nm. The cavity 14 can be shaped accordingly, perhaps slightly larger than the expected sized of the targeted extracellular vesicles. Moreover, the material of the attracting layer 16 can be selected in a manner to offer suitable attractivity to the targeted biological particles, which are extracellular vesicles in this specific example.

MoS₂ was found suitable in terms of attracting layer material in this context as it was found to provide suitable attractivity to extracellular vesicles (EVs) and provide enough interaction time for sensing. Graphene was also tested as a potential attractive material, but was not found to work well with extracellular vesicles such as exosomes. Other potential attracting layer materials were not tested yet but may nonetheless form suitable alternatives to MoS₂ in some embodiments. For instance, other transition metal dichalcogenide monolayers than MoS₂, such as MoSe₂ and MoTe₂, WS2, WSe2, in particular, may work. Experiments have confirmed that MoSe2, WSe2, can work, which suggests that a broader category transition metal dichalcogenide monolayers may work as well. Experiments have shown that multiple layers, e.g. more than 2 layers, or more than 10 layers, didn't work as well. For instance, other molecules having S₂ links may work as well.

In alternate embodiments, the targeted biological particles may be other than extracellular vesicles, such as DNA, RNA, nucleic acid, or bacteria for instance, or even inorganic or non-biological particles in some embodiments, and other transition metal dichalcogenide monolayer materials, or even other monolayer crystalline materials such as perhaps graphene and hexagonal boron nitride may be found to provide better results than MoS₂.

The 2D material can have mono to a few layers, or mono to 10 layers for instance, but at a given number of layers, which may depend on the nature of the material, a material begins to lose its 2D physical properties at the interface including their bandgap and ability to bond with other substances and begins to act as a bulk state. When the number of layers increases over a certain number (which can be between 5 and 10 layers for the example case of MoS₂), the surface atoms of the material lose the tendency to interact with the bilayer lipid as they are involved in a 3D bulk interaction with their surrounding. The thickness of the layers depends on the material that is used, and in some embodiments, maintaining the overall thickness of the 2D material below 100 nm can produce better results.

By contrast with intrinsic attractive properties of 2D materials, surface functionalization and/or using antibodies involve the incorporation of organic substances. Organic substances typically have a more limited lifespan compared to inorganic substances and require specific storage (−20, −80° C.). While inorganic 2D materials such as MoS₂ can have over 6-months of shelf life at room temperature.

Also, using a biorecognition element such as surface functionalization and/or antibodies typically implies being limited to detecting what is known. For instance, there is a limited list of biorecognition markers known for EVs, such as CD9 and CD69, while a number of biorecognition elements are unknown. Using intrinsic materials properties to entrap the particles in the cavities allow us to study the unknown particles as well as known particles.

With this optical interrogation device, one can entrap and measure a combination of known and unknown EVs and study them via a comparative method such as SERS, as opposed to being limited to sorting out EVs based on known biomarkers.

In several commercial embodiments, selecting materials which are stable at room temperature can be a significant advantage and may significantly extend the potential use cases of the technology. Accordingly, while black phosphorous may be suitable as an attracting layer material in some embodiments, it may be rejected in some embodiments or contexts for lack of stability at room temperature.

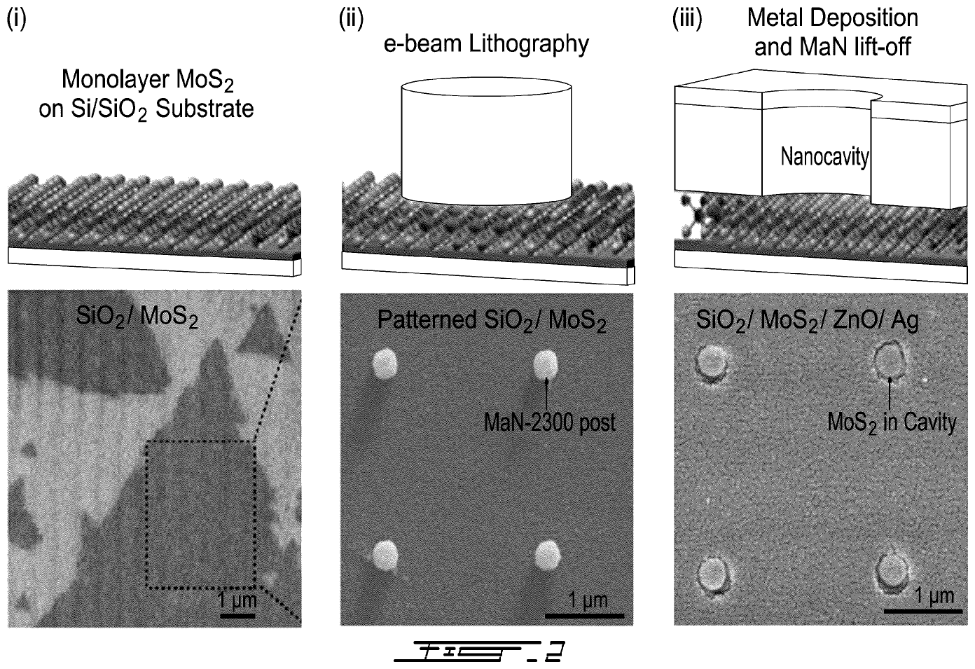

The details of specific embodiments can also be affected by the fabrication technique. As will be understood by persons skilled in the art, various fabrication techniques may be used, which may have their advantages and disadvantages. In the embodiment presented in FIG. 2, which involved depositing (i) monolayer MoS₂ on a Si/SiO₂ substrate, then forming (ii) posts with e-beam lithography, and then (iii) depositing the insulating layer, followed by the plasmonic layer, followed by removal of the posts by MaN liftoff, it was found practical to deposit the attracting layer over the entire exposed surface of the substrate, and to deposit the insulating layer on top, followed by the plasmonic layer. This approach can lead to a scenario where the attracting layer extends not only at the bottom of the cavity(ies), but also under the insulator, which may not be useful but not detrimental either. In some embodiments, it may be preferred to localize the attracting material specifically into the cavities and for the insulator material to be in direct contact with the substrate, for instance. The example fabrication technique by e-beam fabrication can involve a clean room environment and be relatively expensive. In other embodiments, it can be preferred to use fab-less simple chemistry protocols for fabrication, and potentially lead to lower production costs. In the embodiment presented in FIG. 1, the cavity is generally cylindrical in shape, though it will be understood that in alternate embodiments, other shapes may be suitable, or even preferred. For instance, elliptical shaped cavities have been found to work better with elliptical shaped nanoparticles. Indeed, an E-beam lithography method acquiring diluted negative photoresist can be used to lower the cost of lithography while treating the monolayer MoS₂ with electron beam that has been studied to increase the active edge-sites of MoS₂.

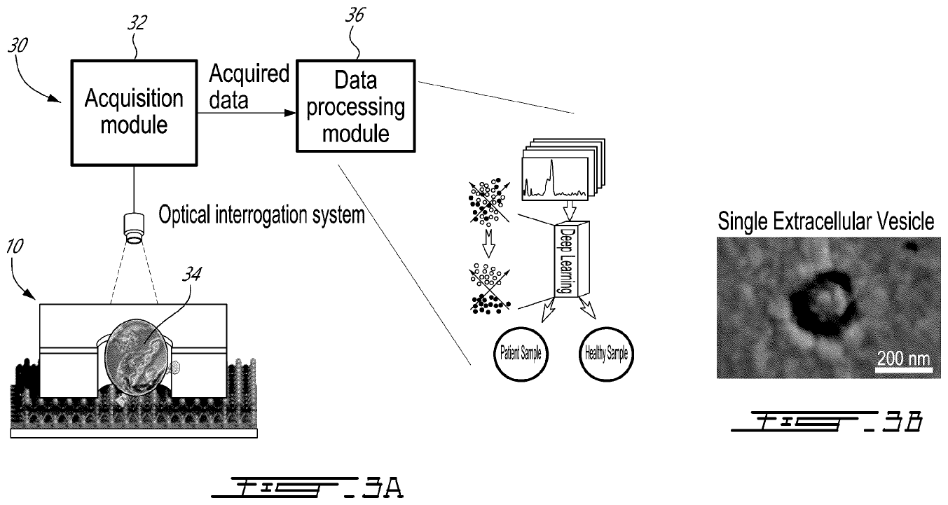

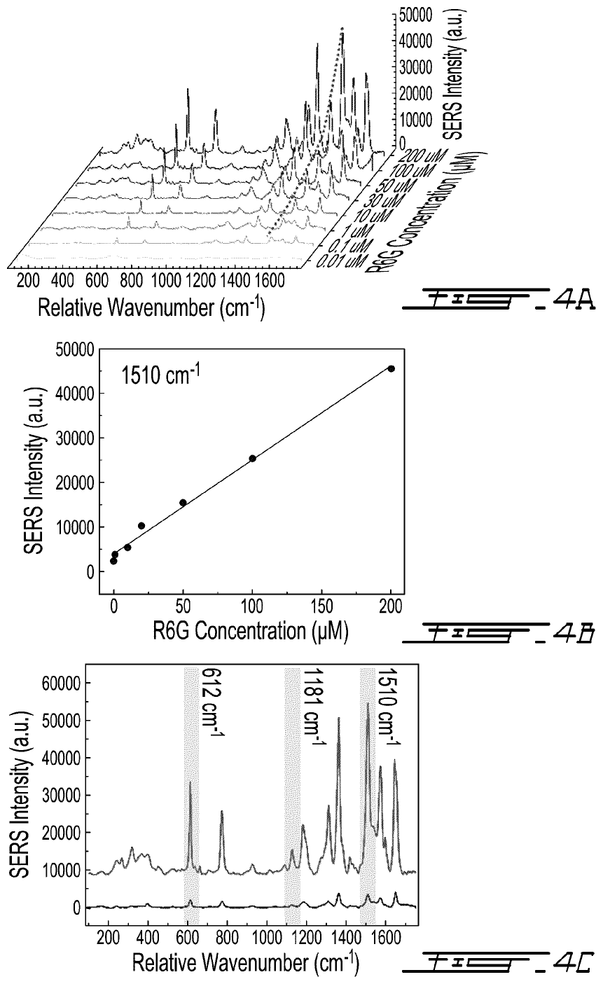

The optical interrogation device 10 presented above in relation with FIG. 1 can thus act as a basis for a single-extracellular vesicle molecular profiling platform enabling single-extracellular vesicle entrapment and surface enhanced Raman spectroscopy (SERS) simultaneously. Referring for instance to FIG. 3, such an example mode of operation is presented. The optical interrogation device 10 is used as a component of an optical interrogation system 30 which can further have an acquisition module 32 including SERS components such as an emitter and a receiver. The particle 34 or particles can be suspended in a solution which is circulated in the vicinity of the cavity. The layer of 2D material at the bottom of the cavity 14 can attract the particle 34 and pull it into the cavity 14 through the open upper end, and retain the particle 34 in the cavity for a sufficient amount of time to perform the optical interrogation, including the acquisition of an optical signal having a spectral signature of the particle. The electromagnetic field distribution in the cavity may suitably interact with bioparticles such as extracellular vesicles. The acquired optical signal can be stored in a non-transitory computer readable memory in the form of data.

One or more data processing modules 36 can be provided either at the acquisition site, at one or more remote locations (which can imply communicating the data over a communications network or disconnecting, moving, reconnecting the computer readable memory), or both, to provide one or more data processing steps. In one example embodiment, a data processing module 36 can be used to classify the aggregated acquired data from a given sample into two or more categories. Such a data processing module can use machine-learning techniques for instance, or conventional algorithms. In one example embodiment which will be described in detail further below, one or more data processing modules can process the data associated to a biological sample in a manner to classify the biological sample as healthy or as patient, for instance. Making regular biological sample checkups in this manner can be particularly useful in some embodiments.

### Example Application

For cancers with low survival rates finding accessible test approaches for early recognition that could be examined on a regular basis is central to oncology research. Glioblastoma is the most common and aggressive primary brain tumor recognized by necrosis and endothelial proliferation as histopathological features. It is one of the dominant causes of cancer-related death with a median survival time of approximately a year after diagnosis and a survival rate of 6-22% depending on the age. De novo approaches for cancer therapeutic are costly and fail to give a rapid, easy to acquire, early indication of disease that can be tested on a regular basis. Minimally invasive precision oncology based on liquid biopsy enabled assessing cancer information rapidly with minimal invasiveness that can assist the clinical procedures. In recent years, advances in liquid biopsy enhanced our ability to extract useful information from tumor-derived substances in the biofluids with less cost compared to genomics and proteomics. However, the sensitivity, specificity, accessibility, and data reproducibility are all dire needs to be addressed. In particular, the precision oncology based on molecular profiling of tumor biomarkers in biofluids which promises accessibility has yet no impact on GBM and in several other malignancies with the current sensitivity. EVs, shed by all cells to the biofluids, bear the cellular fingerprints held in a membrane-bound bilayer lipid allowing to overcome the limitations associated with soluble analytes including proteins and nucleic acids. This nanosized population of cellular fragments contains molecular signatures of donor cell identity, state, and degree of transformation including cancer-driving mutations. Nanostructures were inquired to enhance the sensitivity of the methods designed to advance our knowledge of EVs. EVs carry fingerprints of important oncogenic driver mutations of cells from which they originate, therefore unlike any other liquid biopsy analyte, they can capture remarkable and clinically important heterogeneous cellular traits. Mutational and epigenetic driver events profoundly alter the release, molecular composition, and biological activity of extracellular vesicles. Notably, EVs also carry signatures of GBM molecular subtypes which are diagnostically meaningful and essential for proper stratification of patients included in clinical studies.

The diversity of EVs subpopulations in the biofluid may reflect the cellular complexity of the underlying tumours, a diagnostic opportunity hampered by sensitivity limitations of currently available analytical methods. Surface-enhanced Raman spectroscopy (SERS) is an exceptional analytical approach used for obtaining the fingerprints of analytes in the form of a signal providing advantageous detail regarding their biochemical composition. It provides a biomarker-free specificity based on the unique signal fingerprint of the analyte and is able to determine differences between biological samples collected from healthy and diseased donors. The working principle of SERS is based on the adsorption of analyte molecules to a plasmonic surface (typically a metallic nanoparticle) allowing for a strong enhancement of the Raman signals from the analyte. The main requirement to study the molecular fingerprints of single EVs is a high sensitivity of the sensor which is generally hindered by the diffusion limits of the analytes in the solution and statistical forces. The key elements to the SERS enhancement are the electromagnetic (EM) field enhancement factor and the chemical contribution. In addition, SERS is an inherently non-invasive method that is easy-to-use, fast, reliable, and can be adapted for use in low setting clinical centres with the emergence of handheld instruments and fiber-optic probes. Unlike the imaging diagnostic tools such as MRI for which human interpretation of the results including histopathology is necessary, SERS results can be objective, which makes it a machine-friendly tool.

Machine learning methods are central to overcome the complexity and heterogeneity of the EV populations in the body fluids. Particularly, deep learning algorithms offer the ability to classify large and complicated data such as SERS fingerprints of EVs based on patterns submerged locally. A variety of deep learning algorithms have been widely used in recognition of various biological data, including medical images and signals. It is worth to notice that the changes that occur between spectra of heterogeneous biological samples are oftentimes subtle, therefore, the superior performance deep-learning methods to interpret the collected spectral data, offer an enhanced semiquantitative to quantitative information on the distribution of heterogeneous elements of the samples. Machine learning prediction algorithms learn similarities and differences between classes of data. When the model is built using known data, it can then be exploited to devise a classification prediction on unknown data rendering a specific and accurate medical-related screening and diagnostics. One primary application of prediction algorithms is classifying a library of cells and mutational expressions to investigate the EVs population in CSF while with high enough sensitivity from SERS substrate to record subtle changes in the signal. Deep-learning prediction algorithm thus allows for differentiating the blood samples from healthy donors and donors with a disease.

Monitoring the effect of cell transforming events from wild-type cells to the oncogenic expressed isogeneic cells in blood is of importance for realization of the GBM cancer progression and is an important key for treatment decisions. The study of the molecular fingerprints of single EVs via a sensitive, low-cost, and reliable SERS nanochip can lead to identify a range of possible mutational events responsible for transformation of benign cancer cells to the aggressive ones. Here, a new technological approach was developed for molecular EV profiling via single EV SERS and deep-learning analysis approach. The single EV SERS is harnessed using a new MoS2-embedded floating silver nanocavity nanochip (MoSERS nanochip) which is a radically different technology to simultaneously capture single EVs and render amplified EM-field to generate a fingerprint reflective of the GBM EVs populations. Among the potential targets involved in the development of cancerous cells are variants of the epidermal growth factor receptor (EGFR) including the EGFRvIII, which nurture an in-frame deletion of exons and therefore results in a truncated extracellular ligand-binding domain. As EGFRvIII is prominently expressed in GBM Type-1 pathogenesis with approximately 20-35% of patients harbouring the mutated gene, the investigation of the sensitivity of this prototype was narrowed down in distinguishing the epigenetic transformations of the known populations of EVs and patient CSF donors.

Although the conventional medical systems such as magnetic resonance imaging (MRI) used in laboratories are important keys to diagnostic cancers, an urgent need for fast, sensitive, low-cost, and easy-to-operate point-of-care devices is due for the regular checkup to identify early the need for further medical help. The development of on-chip diagnostic methods is central to a minimally invasive POC (point of care) diagnosis routine for a regular checkup to break the diagnostic gridlock in Glioblastoma multiforme (GBM), since the collection of blood samples is a standard procedure in clinical practice unlike extraction of Cerebrospinal fluid (CSF). The main challenge in using blood as the body fluid providing the EVs biomarker is associated with considerably lower concentrations of the tumor-derived EVs expression in plasma compared to CSF due to the brain-blood barrier effect, and their dilution in blood volume. Here, the MoSERS nanochip and a deep-learning prediction algorithm were used to study the refinement of the changes in the SERS signal from blood donated by healthy individuals and GBM patients demonstrating over 90% accuracy in predicting the category of the EVs into two groups of healthy and unhealthy.

In order to understand the cellular composition of a tumor and the possible cell transformation events via liquid biopsy of the EVs, SERS identification with single EV resolution is relevant. In this example embodiment, a lithographically defined nanochip is used that is more stable than nanoparticle-based systems and incorporates a monolayer MoS₂ to provide a chemically attractive surface while offering more degrees of freedom in the design and tuning of structural parameters. By combining the working principles of plasmonic silver nanocavities, and the chemistry of the monolayer MoS₂ embedded in the cavities, a sensitive and easy-to-use, nanochip was developed to perform single EV SERS identification. The MoS₂ embedded plasmonic nanocavities on a SERS chip (MoSERS) can enable reproducible and amplified SERS enhancement for single EV resolution SERS, providing technology for rapid and sensitive detection of EVs as cancer biomarkers. It offers sensitive EV biomarker identification in CSF and blood while enabling a blood plasma test at the POC. Reproducible nano lithography-based plasmonic substrate enfold stable amplified EM-field over the MoSERS nanochip and allows for higher degrees of design freedom compared to nanoparticle-based SERS substrates. To study the Raman signals of a single EV in the EVs population, the physical parameters of the MoSERS nanochip were fine-tuned, e.g., by changing the materials and the geometry (e.g. dimensions and dimensional ratios) to simultaneously entrap single EVs and enhance the subtle Raman signal from a single EV. The LSPR material and geometrical features have been optimized via simulation and experiment to render strengthen EM-field and consequently an enhanced SERS signal. Previous studies demonstrated the potential interaction modes between 2D materials and lipid bilayer particles.

The MoSERS nanochip assimilates the SERS signal via a floating array of plasmonic silver nanocavities fabricated on a non-plasmonic ZnO wall to form the strong EM-field. In this specific example, a combined bottom-up and top-down fabrication procedure was used to develop the MoSERS nanochip (see FIG. 3). Upon CVD-growth of monolayer MoS₂ on a SiO₂/Si substrate, a negative e-beam lithography is used to pattern the nanocavities. A 532 nm laser was used for SERS to activate localized surface plasmon resonance (LSPR) from the nanocavities and record the diffraction signal from single EV SERS. For the practical utility of the MoSERS nanochip for SERS liquid biopsy of single EVs, the overall operation was simplified to the manual injection of purified EVs. The sample solution containing EVs derived from transformed and non-transformed glial cells as well as EVs derived from CSF fluid and plasma of GBM multiform patients were introduced to the MoSERS nanochip in a small amount (0.2 μl).

The performance of the MoSERS nanochip as a POC check-up device in identifying and distinguishing signals from single EVs was studied using 10 different EVs populations derived from a non-cancerous cell line (NHA), 2 glioma cell lines (U373 and U87) derived from parental cells, as well as in EGFRvIII and PTEN transformed cells, and 2 glioma stem cell lines (GSC83 and GSC1005) derived from wild type cells as well as in EGFRvIII knocked out transformed cells. With conventional principal component analysis of the 10 EVs populations, it was possible to distinguish between different cell lines and mutations within a cell line with average 96% sensitivity. However, the monitoring of EVs within the biofluid requires simultaneous quantification of EVs with the single EV resolution to address the heterogeneity of their population. To overcome limitations of data analysis, here single EV SERS was merged with deep learning data processing techniques towards accurate and sensitive multidimensional identification of EVs.

Raman spectroscopy is an optical read-out system which incorporates the vibrational and rotational modes of chemical bonding structures through spectral peaks based on the recorded scattering of a coherent beam (laser) upon hitting the analyte with typically weak signal intensity. SERS is an enhanced method for the amplification of subtle signal intensities based on strong electromagnetic (EM) fields generated in a plasmonic substrate. The EM-field enhancement factor EFEF, is an essential part to enhance the subtle SERS signal from single-EVs, scales with the 4^{th} power of the EM-field enhancement

$${( \frac{\vert E ( ω ) \vert}{\vert {E}_{0} ( ω ) \vert} )}^{4} .$$

To theoretically study the EM-field enhancement of plasmonic nanocavities in the presence of monolayer MoS₂, a series of simulations were performed via finite-difference time-domain (FDTD) module of Lumerical Solution (v8.21.1781, Lumerical Solutions, Inc.). A TFSF source was used to simulate only a small region of the periodic structure, in order to find the maximally possible EM-field. The Ag/ZnO plasmonic layer was supported by a monolayer MoS₂-covered SiO₂ substrate to match the experimental configuration. All the metallic materials were simulated based on Palik refractive indices, while the refractive index of the non-linear MoS₂ material was determined.

The EM-field enhancement distribution

$${( \frac{\vert E ( ω ) \vert}{\vert {E}_{0} ( ω ) \vert} )}^{2}$$

was simulated in the laser excitation wavelength of 532 nm using a TFSF light source to resemble the Gaussian laser beam. To design the nanocavity array with optimized EFEF, the geometrical parameters and material of the plasmonic features were simulated. The simulated broad-band reflectance spectra showed analogue spectra with a sharp peak at around 600 nm correlated to the diffraction mode. The diffraction mode blueshifts when D increases, as governed by the dispersion characteristics of LSPR. A clear broad dip is observed in all reflection spectra at around 700 nm, indicating the existence of an asymmetric Fabry-Pérot cavity formed by the high-reflective silicon wafer, low-reflective silicon dioxide and ZnO as a middle layer, and a hole-pierced silver layer at the top-most layer. A comparison simulation sweep was designed to compare the EM-filed enhancement based on the light source i.e., TFSF and planewave. The correlated the 2D color map of the EM-field distribution as a function of nanocavity diameter (D), with fixed pitch (P=2 μm) and height confirm the selection of the 200 nm array for the optimized SERS readout. The 2D color map of the EM-field distribution for different Ag thicknesses were simulated at the surface of the substrate show an increment in the maximum EFEF when increasing the thickness to 20 nm followed by a drop and an exponential enhancement as governed by the dispersion characteristics of LSPR. The plasmonic active material alters the refractive index and consequently the absorption and resonance of the nanocavity at different wavelengths. The EM-field distribution

$$( \frac{\vert E ( ω ) \vert}{\vert {E}_{0} ( ω ) \vert} )$$

on a single nanocavity of silver (blue), gold (yellow), aluminum (grey), and copper (orange) using a TFSF light source at 532 nm wavelength demonstrate the premier competence of silver. While the 2D countour plot of the EM-filed enhancement over the wavelength shows the enhanced

$$( \frac{\vert E ( ω ) \vert}{\vert {E}_{0} ( ω ) \vert} )$$

for silver at 500-550 nm period. Having the symmetrical circular structures, the preposition of the laser polarization would not affect the EFEF, equally distributed at the two sides of the nanocavities depending on the light polarization. The EM-field distribution in nanobowtie demonstrating over 2.2×10³ times enhancement factor at the cavity edges and over 400 times enhancement factor at the whole cavity leading to a maximum theoretical EFEF and overall theoretical EFEF of 2.3×10¹³ and 2.5×10¹⁰, respectively. Our theoretical assessment here provides a good understanding of the mechanism governing the plasmonic coupling with monolayer MoS₂, thus it could further facilitate the design of hybridized plasmonic cavity/MoS₂ structures.

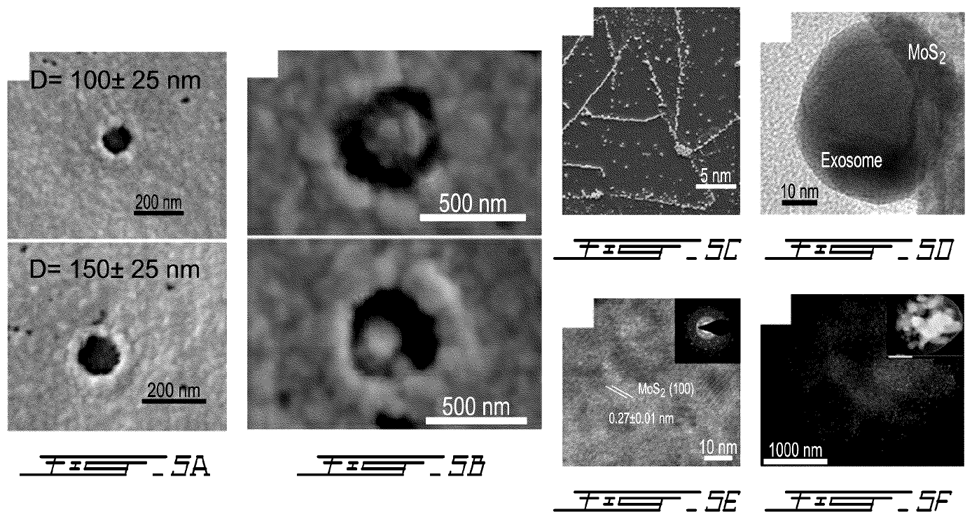

To establish the experimental SERS efficiency resulting from the MoSERS nanocavity structures, Rhodamine 6G (R6G) was used as a well-known marker. Using a 100 times lower power of 532 nm laser (compared to the power used to characterize the EVs), the SERS spectra of R6G was studied in a range of concentrations from 0.01-200 μM (FIG. 4a) resulting in a limit of detection of 0.1 μM and a linear range from 0.1-200 UM with an R2 value of 0.996 (FIG. 4b). The SERS enhancement factor, for many applications, is related to the simple question of how much stronger the SERS signal is produced by an analyte at a given normal mode in comparison with the normal Raman signal of this mode in the same experimental condition. Here, unlike previous studies where the SERS intensity from the plasmonic substrate was compared with Raman intensity from glass, the SERS signal from MoSERS nanocavity was compared with the ones from the SPR substrate consisting of a silver thin-film and a ZnO back reflector similar to the nanochip that the MoSERS nanocavities are patterned in it. The SERS enhancement factor (EF) is calculated according to the

$$\% {EF}_{MoSERS} = \frac{{I}_{MoSERS} {N}_{SERS}}{{I}_{SERS} {N}_{MoSERS}}$$

equation. The SERS intensity of the representative peaks at 612 cm⁻¹, 1181 cm⁻¹, and 1510 cm⁻¹ were studied to calculate the SERS EF (FIG. 4c). The intensity from MoSERS integrated band area at the mentioned peak positions I_{MoSERS} are divided with that of the SERS enhanced signal of the same band, I_{SERS}. N_{SERS} and N_{MoSERS} are the number of analytes for the thin-film Ag sample and that is excited by the localized field enhancement of the MoSERS structure which is calculated to be 0.99 based on the nanocavity active volume of 5.6×10⁻³ μM⁻³. The SERS intensity (I_{SERS}) is directly proportional to the EFEF according to I_{SERS}=F_{S} σ_{S} C_{SERS}EFEF, where F_{S} is an instrumental factor related to Renishaw micro-Raman, σ_{S} is the Raman cross-section of a particular analyte, and C_{SERS} is the concentration of the test analyte. The mapping of the

$$\frac{{I}_{MoSERS}}{{I}_{SERS}}$$

over a patterned part of the silver thin-film with nanocavities and proximate flat silver thin-film demonstrate over 10⁵ times MoSERS EF. To demonstrate the MoSERS hot-spots, the mapped spectra were subtracted by baseline and flatten by the reference R6G spectra from flat silver thin-film. The 2D contour plot mapping of the surface over the full spectra allocates the hot spots derived based of the spectral peak composition. To better demonstrate the hot spots, all the spectra from the mapped region were taken to perform a PCA analysis where the major peak differences were identified by the first and second principal component. The 2D contour plots of the mapped region were generated based on the PC1 and PC2 reference spectra using Origin LAB 2021 and smoothed by a factor of 9, demonstrating well-defined circular spots over the MoSERS pattern.

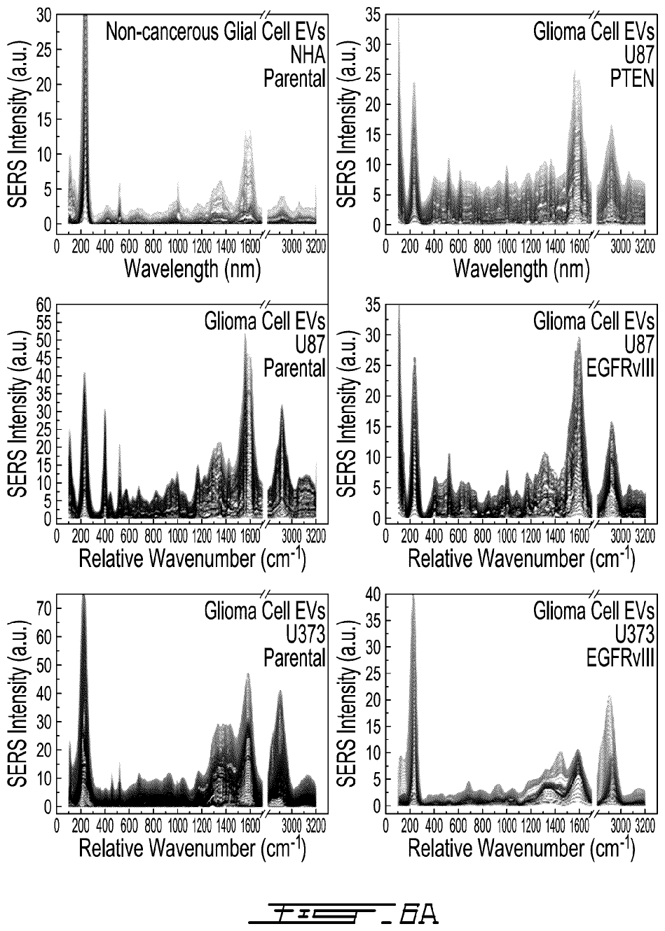

To visually characterize the single EV entrapment in MoSERS nanocavities, scanning electron microscopy (SEM) imaging was used, as shown in FIG. 5a. The representative high-resolution SEM image of the single EVs entrapped in the nanocavities of MoSERS nanochip (FIG. 5b) confirms our hypothesis. The SEM image showing attachment of EVs to the monolayer 2H-phase MoS₂ demonstrates that the majority of the EVs were attracted more towards the edges of the monolayer (FIG. 5c). A ratio of 500:50 EVs on average was found at the edges versus at the basal plane of the triangular single crystalline monolayer MoS₂. The bilayer lipids have a stronger Coulomb and Van der Waals interaction with the S atoms compared to the Mo atoms. The positively charged amino groups (NH₃⁺) can interact with the edge S atoms of the monolayer MoS₂ while the negatively charged phosphate groups (PO₄⁻) were found to have a tendency to interact with the atoms particularly at the edges. In addition, it was found that there is a higher attraction force between the phospholipid bilayer of EVs and the edge-sites of the MoS2 layer compared with the basal plane. Most of the commonly used sulfur-bearing functional groups such as thiol derivatives are known to effectively attach to the monolayer MoS₂. All lipid types contribute similarly to the MoS₂ binding while POPC (1-palmitoyl-2-oleoyl-sn-glycero-3-phosphocholine—a component of a phospholipid layer) have a slightly more important role. The encapsulation of the single EVs in the nanocavities of MoSERS was investigated using the transmission electron microscopy (TEM) approach (FIG. 5d). The hydrophobic interaction of lipid bilayer and proteins with monolayer MoS₂ was hypothesized to form the interaction between monolayer and EV demonstrated by their co-existence. The high-resolution TEM image of monolayer MoS₂ (FIG. 5e) and corresponding Selected Area Electron Diffraction (SAED) pattern in the inset confirming the 2H-phase of the monolayer MoS₂ with 0.27±0.1 nm lattice d-spacing fringes corresponding to the (100) hexagonal plane of Mo atoms and S atoms. The large area EDS mapping with correlated HAADF image enlighten the elemental distribution of C, N, and P related to the EV and Ag, Mo, and S related to the MoSERS nanochip (FIG. 5f).

The SERS identification of single EV is closely related to the ability of trapping the EVs in a plasmonic nanocavity for the test time. The entrapment of single extracellular vesicles in a plasmonic nanocavity is attributed to several factors including the topological modulations of the cavities and the Hydrophobic interactive behaviour of the surface with the EV. 2D materials including graphene and monolayer MoS₂ are investigated to have potential interaction with bilayer lipid materials and surface proteins. Most studies indicated a positive attraction between graphene and MoS₂ nanoparticles. Different molecules including phthalocyanines, are used at the surface of 2D MoS₂ material through noncovalent interactions, while various sulfur-bearing organic molecules are recognized as covalent binding moieties at sulfur vacancies of monolayer MoS₂ In particular, different modes of interactions were found between monolayer MoS₂ and bilayer lipid including a van der Waals interaction of −1419.72 KJ mol⁻¹, and electrostatic interaction of −1380.17 KJ mol⁻¹.

To investigate the entrapment length of the EVs after incubation time in the MoSERS nanocavities, a fluorescent microscopy test was used with fluorescently labelled EVs. Compared to the nanocavities without monolayer MoS₂, the monolayer MoS₂ demonstrates more than twice the efficiency of entrapment on average within the microscope field of view. The normalized fluorescent intensity of the EVs entrapped in the nanocavities with and without MoS₂ in different diameter sizes (100-500 nm) were compared with the normalized fluorescent intensity of the EVs on SiO₂. The normalized fluorescent intensity for each substrate was obtained from over three tests and 10 different random fields of view of the microscope with a 200×250 pi size. The fluorescent intensity collected from nanocavities with MoS₂ (i.e., MoSERS nanocavities) was twice the intensity from the nanocavities without MoS₂ confirming the higher entrapment efficiency of EVs via MoSERS.

The nanocavities with 200 nm in diameter which is a better match with the mean size of the EVs to fit in the cavities have slightly higher fluorescent intensity compared to the nanocavities with other diameters.

A challenge lies in the ability of confining the EVs within the nanocavities during the test time. The normalized fluorescent intensity of the EVs on different substrates has been investigated over time within the same field of view. This comparison shows that fluorescent EVs fluoresce longer on MoSERS nanochip, compared to single crystal monolayer MoS₂, nanocavities without MoS₂, and Silica, respectively. This shows the fluorescent intensity remains steadier on MoSERS nanochip compared to the other substrates. The mapping of the normalized intensity from fluorophores attached to extracellular vesicles in a fixed microscope field of view confirms the longer lifetime of the fluorescent EVs on MoSERS nanochip and the hindrance in the bleaching of fluorophores over test time in the presence of MoS₂ which can be due to the non-linear absorption and large exciton binding energy of the MoS₂. The photoluminescent excitation of monolayer MoS₂ which appears at approximately 1.84 eV (680 nm) and is associated with the direct gap transition at K point, known as “A” exciton, is in favour of surface-enhanced fluorescent microscopy of EVs using conventional bright-field fluorescent microscope.

First, the MoSERS nanochip was assessed for single EV SERS using the well-characterized EV standards isolated from glioblastoma multiform cancer cell line as well as glioma stem cell lines. To characterize the SERS signals, Raman spectra were measured using a 150 second measurement time via a 532 nm HE laser on close to dry samples (0.2 μl). The EVs were isolated from a non-cancerous glial cell line (NHA), two glioma cell lines (U87 and U373) and two glioma stem cell lines (GSC83 and GSC1005). In light of identifying a tumor's composition, it is vital to enable recognition of the cell mutations. As a proof of principle, here EVs derived from EGFRvIII mutated cells of both U87 and U373 glioma cell lines were studied as well as EVs from PTEN mutated cells of U87 cell line. While the EGFRvIII knocked out gene was investigated in GSC83 and GSC1005 glioma cell lines (FIG. 4). The epidermal growth factor receptor (EGFR) is altered in almost 35% of malignant glioblastomas type I, where 20% of tumors expressing the constitutively active mutant EGFRvIII protein. In particular, EGFRvIII is a unique protein which is the result of a tumor-specific gene rearrangement mutation. Mutated EGFRvIII signalling in gliomas leads to increased proliferation, survival, and invasion of tumor cells which can be critical for tumorigenesis. On the contrary, the tumor suppressor protein and phosphatase PTEN opposes the kinase PI3K, resulting in inhibition of the kinase Akt downstream of PI3K, thus reduces cellular proliferation. Therefore, EGFRvIII is an interesting target for early cancer liquid biopsy and identification which makes it an ideal object to investigate the performance of MoSERS nanochip in amplification of single EV SERS spectra fingerprints of the targeted EVs population.

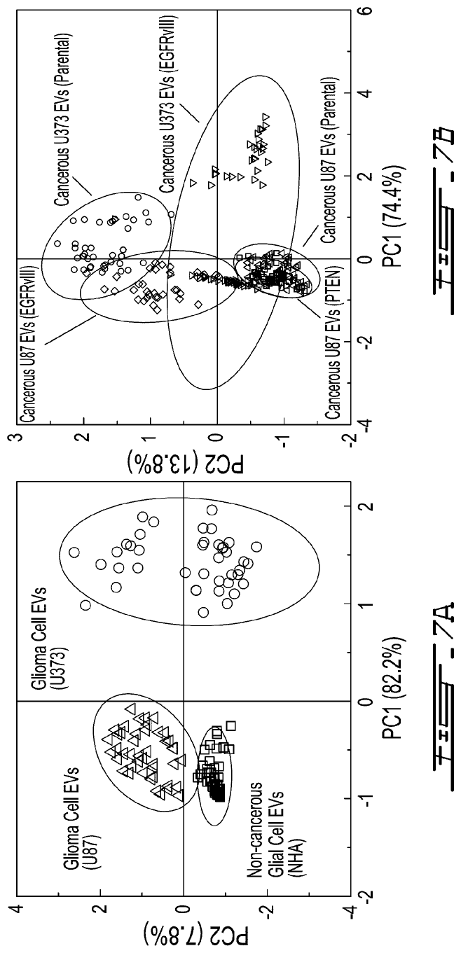

RT2 Profiler™ PCR array were used to study the expression of 84 key genes involved in the EGFRvIII and PTEN expression in U87 and the EGFRvIII expression in U373 glioma cell lines presented in heatmap format. The genes listed were sorted based on overall expression levels. The correlative ΔΔCₜ method shows a 2-fold change in the Parental/EGFRvIII and EGFRvIII/PTEN expression in U87. Similarly, a 2-fold change was detected in the Parental/EGFRvIII expression ratio was seen in U373. The western blotting results further confirm the expression of EGFRvIII in EVs derived from mutated U87 and U373 cell lines. To overcome the complexity of the differentiation when considering the heterogeneity caused by mutations in multiple cell lines, machine learning methods were employed. The baseline of each spectrum is eliminated, and the resulted spectra are normalized and smoothed with a factor of 9. EVs derived from all cell lines shared peaks associated with the characteristic Raman bands of bilayer lipid and common proteins, including phospholipid at 1000 cm⁻¹ tyrosine at 1220 cm⁻¹, and CH₂—CH₃ deformation at 1435 cm⁻¹. Initially, a principal component analysis (PCA) was used to differentiate and identify the major pattern differences between EVs from different glioma cells and non-cancerous cells (FIG. 7a) followed by investigating EGFRvIII and PTEN mutations from glioma cells (FIG. 7b). Each dot in the plot represents one spectrum with dimension reduction and the corresponding ellipses indicate the boundary of each glioma cells EVs population showing a 95% confidence of existence. Each data set was clustered while maximizing covariance. The sensitivity of the MoSERS in differentiating glioma cells U87, U373 and non-cancerous glial cells NHA was calculated to be 96% on average, while the selectivity was calculated to be 97% on average, respectively. Similarly, PCA analysis was used to study the differentiation of healthy glial cells (NHA) from the glioma STEM cells (GSC83 and GSC1005) (FIG. 7c) followed by investigating the EGFRvIII mutations from GSC cell lines (FIG. 7d). The PCA analysis demonstrated an average sensitivity of 96% in distinguishing EVs from different cell lines as well as an average sensitivity of 81% in distinguishing EVs from different mutations in the same cell line. While it fails to distinguish the EVs from different mutations derived from different cell lines at the same time.

The sensitivity of MoSERS SERS approach was specifically studied with respect to distinguishing EGFRvIII mutations. The human recombinant EGFR (rh-EGFR) and human recombinant EGFRvIII (rh-EGFRvIII) proteins were investigated using MoSERS to determine the feasible peak ratio alteration from rh-EGFR to rh-EGFRvIII protein. The EGFR protein is a single-chain transmembrane protein made of an extracellular EGF-binding domain which is a short transmembrane sequence and a cytoplasmic region that incorporates a protein tyrosine kinase domain and a C-terminal phosphorylation domain. The SERS intensity shows a considerable increase in intensity at 1430 cm⁻¹ and 1562 cm⁻¹ peak position while demonstrating a decrease in the intensity at 1345 cm⁻¹ and 1591 cm⁻¹ intensity in rh-EGFRvIII compared with rh-EGFR SERS fingerprint. The considerable peak ratio difference which occurs at 1430 cm⁻¹/1345 cm⁻¹ was studied in EVs population from U87 and U373 cell lines demonstrating a P-value below 0.001 for both cases. The increase in the Peak intensity ratio at 1430 cm⁻¹ over 1345 cm⁻¹ correlate to the more pronounced expression of Leucine/histidine over tyrosine in EGFRvIII EVs compared to the EVs from cells with wild type EGFR receptor. The radiometric analysis of Parental exosomes and EGFRvIII expressed exosomes was studied in U373 cell-line. Expectedly, a similar trend was detected in the spectra dataset of EVs derived from glioma cell supernatant which is in compliance with the studies of the proteins.

Accordingly, the teachings presented above can be adapted for detection of cell transforming events for different applications. It can be used for cancer diagnosis to investigate cell mutations responsible for cancer stage. It can also be used for screening the effect of personalized drugs in treatment of such mutational transformations. On the other hand, our platform can be used to understand the “aging-induced” mutations characterized by a decrease in genome integrity to assist with organ maintenance.

In some embodiments, it was found convenient to create one or more crystalline defects in the attracting layer of 2D material exposed at a bottom of the cavity. In some circumstances, the crystalline defects (e.g., edges) can enhance the particle attraction and retention in the cavity. More specifically, the SERS identification of single EV is closely related to the ability of trapping the EVs in the plasmonic nanocavities for the test time to enhance the subtle SERS signal from single-EVs. The hydrophobic interactive behaviour of the MoS₂ layer with the EVs as a physical interaction can be one of the reasons for the absorption of EVs in the nanocavities. Single crystalline monolayer MoS₂ can demonstrate potential interaction with bilayer lipid materials. In an example experiment, electron microscopy was used to visualize the physical connection between monolayer MoS₂ and phospholipid after sample preservation. The SEM image showed attachment of EVs to the 2H-phase monolayer MoS₂ demonstrated that the majority of the EVs were attracted to the edges of the monolayer of attracting material. A ratio of 10:1 EVs on average was found at the edges of the monolayer versus at the basal plane of the triangular single crystalline monolayer MoS₂. There can be substantial atomic crystalline defects present at the edges of the monolayer MoS₂ that can actively interact with lipid bilayers. In addition, to ensure the edge sites expression in the nanocavities, a pre-treatment E-beam positive lithography on monolayer MoS₂ was used to introduce and create defect sites on the basal plane of the monolayer, which in turn promotes the adhesion of the EVs to the MoS₂ in the nanocavities.

In an experiment, molecular dynamics (MD) simulation was used to probe the physical origin of the interactions between monolayer MoS₂ and phospholipid, using a realistically constructed phospholipid bilayer incorporating previously reported components of the EV membrane (cholesterol (CHL), POPC, TSM, POPS and POPE). When a phospholipid bilayer got close to a MoS₂ layer, the gradient of potential energy resulting from Van der Waals and Coulomb energies made the phospholipid membrane interact with the MoS₂ layer. The origin of this interaction can be relevant to the inorganic entrapment sites for single EVs biomarkers. The MD simulation analysis confirmed a higher attraction force between the phospholipid bilayer of EVs and the edge-sites of the monolayer MoS₂ compared with the basal plane. The simulation was initiated by positioning the MoS₂ layer parallel to the constructed phospholipid membrane and the membrane freely moves. The MoS₂ layer was freely flipping, and there is no considerable attraction force between the MoS₂ layer and the membrane before 100 ns when the monolayer rotated approximately 90 degrees, and the edge of the layer got closer to the membrane. Once the phospholipid membrane and the monolayer MoS₂ started to interact with each other, the level of energy reached a minimum level resulted by absorption of the layer inside the membrane. The simulations were carried out (using GROMACS software package) with the design of phospholipid bilayer to integrate five different lipid components, while the force field parameters of MoS₂ were derived. PME method was applied to handle the long-range electrostatic interactions and the van der Waals (vdW) interactions were computed with a cut-off of 1.2 nm. To evaluate the free energy changes during the insertion process, the potential of mean force (PMF) was calculated along the direction perpendicular to the phospholipid bilayer surface. The PMF is able to evaluate the binding free energy, which was calculated according to the umbrella sampling simulations. During PMF calculations, the MoS₂ nanosheet was vertically pulled away from the membrane-forming various configurations. Then, the perpendicular distance of center of mass of MoS₂ nanosheet with its corresponding initial position was regulated at reference distances (d₀) via a harmonic force, F=k×(d−d₀), where k is the force constant (2000 KJ mol⁻¹ nm⁻²). Consistent with our previous findings, an attractive force between the monolayer MoS₂ and phospholipid bilayer was demonstrated. More specifically, it was found that when a phospholipid bilayer comes close to a MoS₂ layer, the gradient of potential energy resulting from van der Waals and Coulomb energies can cause the phospholipid membrane to interact with the MoS₂ layer. The energies reach a minimum value of −3133.02 KJ mol⁻¹ and −809.04 KJ mol⁻¹ for van der Waals and Coulomb, respectively. A stable membrane comprising the five components listed above served to study the minimum energy level after absorption of a layer inside the membrane and the attraction forces of the phospholipid bilayer interaction and MoS₂, while the overall contact number of each component of the phospholipid bilayer was also simulated. The interaction forces corroborate the preference of MoS₂ crystalline defects such as edge sites to interact with EVs lipid bilayer which is essential for enhanced, high-capacity entrapment of EVs.

In another aspect, the EV-nanocavity interaction with EVs that drives the uniform array loading can have a significant effect on the performance of the device presented herein. These rectangular arrays of nanocavities with variety of diameter size can be fabricated into arbitrary shapes. The EVs are introduced into the array by direct pipetting of a 1-10 μl drop of EV-containing solution into the MoSERS fluidic device. The EVs have a size range between 150-200 nm in diameter. Fluorescent labelling is used (Dil) to study EV interaction with the MoS2 monolayer and observe how this interaction affects EV loading in the nanocavity array.

One of the important challenges to address is the ability of confining the EVs within the nanocavities during the test time. The normalized fluorescent intensity of the EVs on different substrates has been investigated over time within the same field of view. This comparison shows that fluorescent EVs fluoresce longer on MoSERS microchip, compared to single crystal monolayer MoS2, nanocavities without MoS2, and Silica, respectively. This shows the fluorescent intensity remains steadier on MoSERS microchip compared to the other substrates. The mapping of the normalized intensity from fluorophores attached to exosomes in a fixed microscope field of view confirms the longer lifetime of the fluorescent EVs on MoSERS nanochip and the hindrance in the bleaching of fluorophores over test time in the presence of MoS2 which can be due to the non-linear absorption and large exciton binding energy of the MoS2. The normalized fluorescent intensity of the EVs entrapped in the nanocavities with and without MoS2 in different diameter sizes (100-500 nm) were compared with the normalized fluorescent intensity of the EVs on SiO2. The normalized fluorescent intensity for each substrate was obtained from over three tests and 10 different random fields of view of the microscope with a 200×250 pi size. The fluorescent intensity collected from nanocavities with MoS2 (i.e. MoSERS nanocavities) was twice the intensity from the nanocavities without MoS2, confirming the higher entrapment efficiency of EVs via MoSERS. The nanocavities with 200-250 nm in diameter, which is a better match with the mean size of the EVs to fit in the cavities, have slightly higher fluorescent intensity compared to the nanocavities with other diameters.

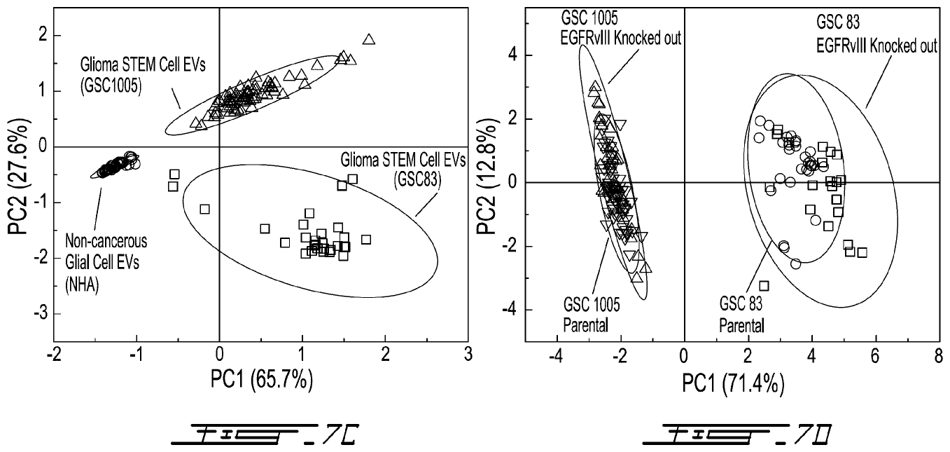

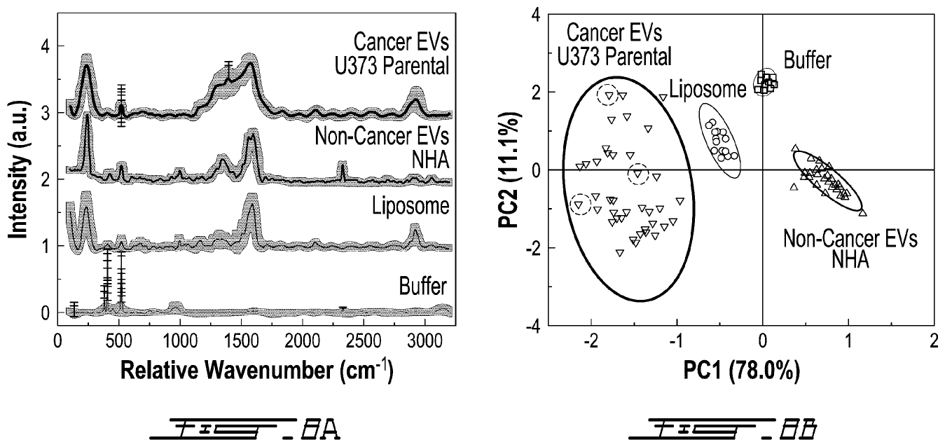

The ability to entrap and isolate single EVs in the MoSERS nanocavities suggests that the approach presented herein can be used to perform SERS on a single vesicle basis. To explore this possibility, MoSERS spectra were first obtained from synthetic liposomes. Liposomes are chemically uniform and provide an estimate of the expected intrinsic variation of the single-vesicle SERS recordings. Next, EVs produced by human glial cells (NHA, non-cancerous) were analysed and then EVs produced by cultured human glioma cells were investigated, such as shown in FIGS. 8A and 8B. All recordings were obtained by scanning a vesicle loaded MoSERS device cavity by cavity at 532 nm. For each raw SERS spectrum recorded, the spectrum baseline is subtracted, and the resulting spectrum is normalized and smoothed. As best shown in FIG. 8A, the averaged processed spectra obtained from the EV populations indicate shared peaks associated with the characteristic Raman bands of bilayer lipids and common proteins in EVs. To characterize the variation of spectra obtained from single EVs, a multivariate principal component analysis (PCA) was performed. PCA reveals principal component loadings with clearly separated clusters that quantitatively reflect the major differences in single EV spectra, effectively discriminating between EVs of the human non-cancer cells, glioma cells and liposomes, such as shown in FIG. 8B.

With the ability of MoSERS to detect distinct EV spectra, this approach may further be used for more complex biological samples containing EVs from multiple cellular sources, such as blood. Thus, MoSERS spectra were obtained from EVs isolated from blood samples drawn from 8 healthy individuals and 12 patients clinically diagnosed with glioblastoma (GBM). Clinical annotations of 10 patients were received to correlate with the SERS study in the following section from a pathology study at the Montreal Neurological Institute and Hospital (MNI). Prior to start the SERS characterization, the isolated EVs were tested using PCR via EGFR cDNA amplification to correlate with the clinical data. To analyze the single EV spectra, the residual neural network (Resnet)-based convolutional neural network (CNN) algorithm was used, as a proof-of-concept to classify their possible cellular sources and infer molecular hallmarks of the underlying disease. To this end, a CNN algorithm was trained with the spectra from healthy and cancerous cell lines, as well as unseen (blinded) spectra set of 2 healthy and 2 patient samples, followed by testing the MoSERS spectra in the remaining samples. The probability that sampled EVs carry one of the three molecular GBM-associated alterations (epidermal growth factor receptor (EGFR) amplification, EGFRvIII, and O⁶-methylguanine-DNA-methyltransferase (MGMT) methylation) were determined based on a Mahalanobis distance. A total of 70 EVs were measured for each blood sample. The probability score for each individual sample shows a higher similarity between the test EVs from patient samples and cancerous variants compared to the ones derived from the healthy individuals. The convergence of training and validation values for loss and accuracy verifies that the algorithm has been successfully trained. Receiver operating characteristic (ROC) curves were used to assess the overall true positive rate versus false negative rate of the MoSERS-based single EV prediction of underlying molecular traits, which resulted in an overall area under the curve (AUC) of 85%.

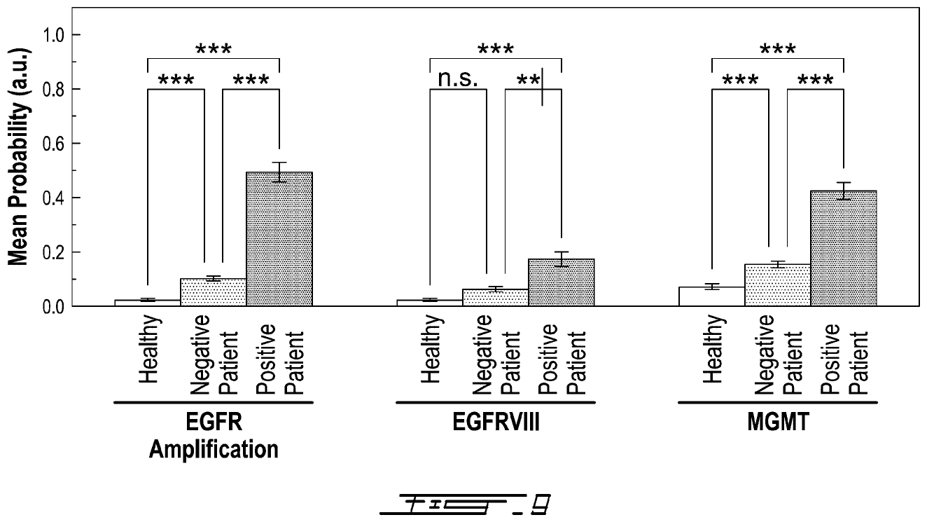

To achieve the correlation of these results with clinical annotations, the probability scores of positive-variant patients were compared with negative-variant patients and healthy subjects. The healthy control, negative-variant patient group and individual positive-variant patients were assessed using one-way analysis of variance (ANOVA) with posthoc Tukey's test. ANOVA detected an overall significant difference among the majority of the positive-variant individuals (P<0.001) compared to the negative-variant pool. The samples were grouped as healthy subjects, GBM patients negative for genetic variant and GBM patients positive for genetic variant. Positive variant patients demonstrate a relatively higher probability of having the variant gene compared to negative variant patients and samples from healthy donors, such as shown in FIG. 9. The ROC curve for the individual patients based on the accumulative probabilities of the single EVs carrying one of the three molecular GBM-associated alterations demonstrates an overall area under the curve (AUC) of 91%.

As briefly discussed above, the optical interrogation device described herein can be part of a microfluidic device 50. An example of which is shown in FIG. 14. More specifically, the depicted microfluidic device 50 has a base plate 52 which defines a microfluidic conduit 54 extending between an inlet 56 and an outlet 58. As illustrated, the optical interrogation device 50 is disposed within the microfluidic conduit 54, between the inlet 56 and the outlet 58. Accordingly, when a fluidic stream carrying the particle flows from the inlet 56 towards the outlet 58, the particle can be attracted within the cavity of the optical interrogation device 10 for optical interrogation. In some embodiments, a filter 60 can be positioned upstream from the optical interrogation device 10 to filter out some undesirable particles or debris. As shown in this embodiment, a suction screw 62 in fluid communication with the outlet 58 can be actuated to force movement of the fluidic stream along the microfluidic conduit. It is intended that the suction screw can be operated in a manual or automated manner such as to control the movement of the fluidic stream between optical interrogations. In this embodiment, a suction screw receiver 64 sized and shaped to fit atop the outlet 58 of the base plate 52 is shown. The suction screw receiver 64 has a through aperture with one end being hermetically disposed over the outlet 58 of the base plate 52, and another opposite end hermetically receiving the suction screw during use. In some embodiments, the base plate 52 is formed using 3D printing techniques. The base plate 52 may accommodate more than one spaced apart microfluidic conduit 54, which may share a single inlet 56 and/or a single outlet 58, depending on the embodiment. In some embodiments, it was found convenient to position a polymer (e.g., PDMS) cover atop the base plate.

As can be understood, the examples described above and illustrated are intended to be exemplary only. For instance, in other embodiments, the optical interrogation device can be integrated to other types of microfluidic devices, such as digital microfluidic devices, droplet microfluidic devices, or be used in applications other than microfluidic devices. It will be understood that the nanoparticles may be spherical, and typically are when between 100 and 1000 nm, but they may have other shapes as well, e.g. elliptical, and the expression “size” refers to a major dimension of the particle (e.g. length). The scope is indicated by the appended claims.

1. An optical interrogation device comprising:
a substrate;
an insulating layer supported by the substrate;
a plasmonic layer supported by the insulating layer;
a cavity extending across both the plasmonic layer and the insulating layer to a bottom adjacent the substrate, the cavity being sized to receive a particle; and
a layer of 2D material covering the substrate and defining the bottom of the cavity.

2. The optical interrogation device of claim 1 wherein the layer of 2D material covering the substrate is an attracting layer of 2D material, the 2D material being intrinsically attractive to the particle.

3. The optical interrogation device of claim 1 wherein insulating layer has a thickness between 20 and 600 nm, the plasmonic layer has a thickness between 5 and 400 nm, and the cavity having a cross-sectional width less than or equal to a sum of the thickness of the plasmonic layer and the thickness of the insulating layer.

4. The optical interrogation device of claim 1 wherein the cavity has a depth of between about 30 and about 600 nm, and a cross-sectional width of between about 30 and about 600 nm.

5. The optical interrogation device of claim 4 wherein the depth and cross-sectional width are below 250 nm.

6. The optical interrogation device of claim 5 wherein the depth and cross-sectional width are above 100 nm.

7. The optical interrogation device of claim 1 wherein the plasmonic layer is made of a plasmonic metal.

8. The optical interrogation device of claim 7 wherein the plasmonic metal is silver.

9. The optical interrogation device of claim 1 wherein the plasmonic layer has a thickness between 5 nm and 100 nm.

10. The optical interrogation device of claim 9 wherein the insulating layer has a thickness between 1 and 4 times the thickness of the plasmonic layer.

11. The optical interrogation device of claim 1 wherein the plasmonic layer has a thickness between 100 nm and 200 nm.

12. The optical interrogation device of claim 11 wherein the insulating layer has a same thickness as the thickness of the plasmonic layer.

13. The optical interrogation device of claim 1 wherein the insulator is one of nitride-based and oxide-based.

14. The optical interrogation device of claim 1 wherein the 2D material is a transition metal dichalcogenide.

15. The optical interrogation device of claim 14 wherein the 2D material is molybdenum disulfide (MoS2).

16. The optical interrogation device of claim 1 wherein the 2D material has between one and 10 monolayers of crystalline inorganic material.

17. The optical interrogation device of claim 16 wherein the crystalline inorganic material has a bandgap feature detectable by optical interrogation.

18. The optical interrogation device of claim 1 wherein the 2D material has a thickness of less than 100 nm.

19. The optical interrogation device of claim 1 comprising a plurality of said cavity, said cavities being interspaced from one another along the substrate.

20. The optical interrogation device of claim 1 wherein the layer of 2D material has a crystalline defect exposed at the bottom of the cavity.

21.-49. (canceled)
